(19) United States
(12) Patent Application Publication
(10) Pub. No.: US 2025/0064016 A1
(43) Pub. Date: Feb. 27, 2025

(54) PET IDENTIFICATION AND MANAGEMENT SYSTEM

(71) Applicant: PREVAILING PAW, LLC, Irvine, CA (US)

(72) Inventor: Michael Tong, Irvine, CA (US)

(73) Assignee: PREVAILING PAW, LLC, Irvine, CA (US)

(21) Appl. No.: 18/235,900

(22) Filed: Aug. 21, 2023

(51) Int. Cl. A01K 5/02; A01K 11/00; G06N 20/00

(52) U.S. Cl. CPC A01K 5/0291; A01K 11/006; G06N 20/00

(57) ABSTRACT

A pet management system to identify each of a plurality of different pets and to manage pet services assigned to each of the plurality of pets based on an identification of each pet and a determination as to whether a specific pet is within a predetermined range of the assigned pet service.

### STATEMENT REGARDING FEDERALLY SPONSORED RESEARCH OR DEVELOPMENT

Not applicable.

### COPYRIGHT NOTICE

A portion of this disclosure contains material which is subject to copyright protection. The copyright owner has no objection to the photocopy reproduction by anyone of the patent document or the patent disclosure in exactly the form it appears in the Patent and Trademark Office patent file or records, but otherwise reserves all copyright rights whatsoever. 37 C.F.R 1.71 (d).

### BACKGROUND OF THE INVENTIVE CONCEPT

### 1. Field of the Invention

The present inventive concept relates to a system to identify pets and to manage pet services based on the identification of each pet. More particularly, but not exclusively, this inventive concept relates to a system to identify individual pets and to manage pet services for each of the individual pets based on the identification of each pet, such that unique services can be provided to each individual pet based on the identification of the pet at a pet servicing location.

### Description of the Related Art

When more than one pet is in a household or in a pet boarding center the tasks of keeping track of and managing different required pet services for each of these pets becomes complicated and even daunting. For example, when a pet boarding center has a plurality of dogs retained therein the tasks of ensuring that each of the dogs are fed their proper food and medications, etc., and that one dog does not eat the food or medication intended for another dog, becomes a full-time responsibility for one or even a group of people. Although automatic replenishment of food has been used, any animal can eat the replenished food, thus not taking into account each pet's specific needs. Other attempts at monitoring animals have been conducted, but there is no system provided which can detect, monitor and manage pet services.

U.S. Pat. No. 10,713,536 by Ke discloses a camera method with animal recognition and camera monitoring. More specifically, this patent is directed to capturing an image of a moving object when the object moves into a camera's range. The captured image is then transmitted to an identification system to determine an animal category of the animal to classify and store the captured image. However, there is no identification of any specific pet taught or disclosed in this patent, and there is no management of any animals discussed in this patent.

CN 114793929A discloses a pet feeding system based on visual identification and detection of multiple species of pets. This system is limited to classifying one type of pet from another, such as a dog from a cat. Here video streams are acquired through a camera and sent to an image detection and classification module. If there is a target pet in the image, the image is sent to an image classification model for pet category classification. When the image classification model receives the image with the target pet, the target pet in the image is classified and the classification result is counted. When a number of a certain type of pet reaches a preset value a control module generates a corresponding control signal, where the control signal realizes grain adding by opening a corresponding grain storage mechanism and controls an audio module to play a corresponding voice command. The video and the image of the certain type of pets are transmitted to a cloud end information communication connection with an intelligent feeding device, and the voice command is a voice command for calling the owner. Then the owner can send out a control instruction to control the food storage mechanism to add cat or dog food to feed their pet.

Accordingly, there is a need for a system to monitor a plurality of pets and to determine when each pet is within a certain range of a corresponding assigned pet feeding device to provide each pet with access to food within the corresponding assigned feeding device when a scheduled feeding time occurs.

There is also a need for a system to monitor a plurality of pets and to determine when each pet is within a certain range of a corresponding assigned pet servicing device to provide each pet with access to the service provided at the corresponding assigned pet servicing device when a scheduled service time occurs.

There is also a need for a system to monitor a plurality of pets and notify a user through an APP when the user's pet is within a certain range of an assigned feeding or servicing device for the pet.

### SUMMARY OF THE INVENTIVE CONCEPT

The present general inventive concept provides a system to detect individual pets and to manage pet services for each of the individual pets based on the detection of each pet such that unique services can be provided to each individual pet based on the detection of the pet at a pet servicing location.

Additional features and utilities of the present general inventive concept will be set forth in part in the description which follows and, in part, will be obvious from the description, or may be learned by practice of the general inventive concept.

The foregoing and/or other features and utilities of the present general inventive concept may be achieved by providing a pet management system, comprising: an edge computer control system including: an application graphic user interface (GUI) to receive videos of a pet, a name of the pet and a schedule of management times for the pet to create a pet profile; at least one database to store the pet names, videos and schedules of the pet management times for each pet profile; a first wireless communications interface to wirelessly communicate with at least one pet management device; and at least one computer processor configured: to train and store identification models to analyze video frames of videos received through the GUI to identity a pet and associate the name with the pet, to transmit instructions to a pet management device assigned to a pet profile to capture videos of pets when a scheduled pet management time occurs; to store object detection and tracking models to detect and track pets and location coordinates of the pets from video frames received from the assigned pet management device and determine whether a detected pet in one frame is the same pet detected in a later frame, and to identify the detected and tracked pets and transmit an identification signal confirming whether an identified pet is close to the assigned pet management device through the first wireless communications interface; and at least one pet management device including: a second wireless communications interface to wirelessly communicate with the edge computer control system to: receive instructions to capture videos at the pet management device; transmit the captured videos to the edge computer control system; and to receive identification signals from the edge computer control system indicating whether a pet assigned to the pet management device is close to the pet management device; a proximity detector to detect whether a pet is within proximity to the pet management device, and a management processor to operate the pet management device to open when the identification confirmation signal received from the edge computer control system confirms that the assigned pet is close to the pet management device; and when the proximity detector detects that a pet is within proximity to the pet management device.

In an exemplary embodiment, the GUI is accessible at personal mobile electronic devices via an App and the Internet.

In another exemplary embodiment, the at least one pet management device can include a plurality of pet management devices, wherein each of the plurality of pet management devices is assigned to a specific pet profile.

In another exemplary embodiment, the at least one database can include: a pet information database to store input pet names and input videos of pets; and an application database to store input pet management schedules.

In still another exemplary embodiment, the edge computer control system can further include: a plurality of identification models each programmable to identify a pet from the created pet profiles and to identify a pet from the detected and tracked pet.

In still another exemplary embodiment, the edge computer control system can further include: an object detection model programmable to detect objects from video frames received from the at least one pet management device; and an object tracking model programmable to track the detected objects and determine coordinates of the detected objects.

In yet another exemplary embodiment, the at least one pet management device is a pet feeder device.

The foregoing and/or other features and utilities of the present general inventive concept may also be achieved by providing a pet management system, comprising: an edge computer control system including: an application graphic user interface (GUI) to receive videos of a pet, a name of the pet and a schedule of management times for the pet to create a pet profile; at least one database to store the pet names, videos and schedules of the pet management times for each pet profile; a first wireless communications interface to wirelessly communicate with at least one pet management device; and at least one computer processor configured: to identify pets using the videos and pet names received through the GUI, to transmit instructions to one of a plurality of pet management devices to capture videos of pets within a surrounding environment when a scheduled pet management time occurs; to detect objects and location coordinates of the objects from video frames received from the one of a plurality of pet management devices and determine whether a detected object in one frame is the same object detected in a later frame, and to identify a specific pet from the detected and tracked objects and transmit identification signals confirming whether the identified pet is close to the one of a plurality of pet management devices through the first wireless communications interface; and at least one pet management device including: a second wireless communications interface to wirelessly communicate with the edge computer control system to: receive instructions to capture videos; transmit the captured videos to the edge computer control system; and receive the transmitted identification signals from the edge computer control system; a proximity detector to detect whether an object is within proximity to the pet management device, and a management processor to operate the pet management device to open when: an identification signal received from the edge computer control system confirms that the pet is close to the pet management device; and when the proximity detector detects that an object is within proximity to the pet management device.

In an exemplary embodiment, the at least one pet management device is a pet feeder device.

The foregoing and/or other features and utilities of the present general inventive concept may also be achieved by providing a method of managing pets with a pet management control system, the method comprising: generating a graphic user interface (GUI) accessible via an APP and the Internet, the GUI enabled to receive a pet name and videos of a pet to create a pet profile, and to receive a schedule of management times for the pet; storing the created pet profiles, the input pet names and scheduled pet management times in at least one database; training AI based identification models to identify a pet and associate a name with the identified pet from video frames of a pet and a pet name received through the GUI; wirelessly transmitting instructions to one of a plurality of pet management devices to capture videos when a scheduled pet management time occurs; receiving the captured videos from the pet management device in response to the instructions transmitted to capture videos; detecting and tracking location coordinates of a pet in the received video frames and determining whether the detected pet in one frame is the same pet detected in a later frame; identifying the detected and tracked pet; wirelessly transmitting identification indication signals to the pet management device which indicate whether the identified pet is within a predetermined distance from the pet management device; detecting a proximity of an object at the pet management device; and operating the pet management device to open when the identification indication signal indicates that the specific pet has been identified and when an object has been detected to be within proximity of the pet management device, otherwise keeping the pet management device closed.

### BRIEF DESCRIPTION OF THE DRAWINGS

These and/or other features and utilities of the present inventive concept will become apparent and more readily appreciated from the following description of the embodiments, taken in conjunction with the accompanying drawings of which:

FIG. 1 illustrates a pet management system configured to learn identifiable information regarding a plurality of different pets and to manage pet services to be provided to the pets based on the detection of each pet, according to an example embodiment of the present inventive concept.

FIG. 2 illustrates a setup process for training a computing system, according to an example embodiment of the present inventive concept, to learn how to identify different pets among a plurality of pets provided.

FIG. 3A illustrates the overall second “runtime” phase operations performed to manage a plurality of pets based on a trained computing system, as described in FIG. 2, according to an example embodiment of the present inventive concept.

FIG. 3B illustrates a summary of the operations of the different units in the edge computer control system 110 and in the pet feeder device 120 during the second “runtime” phase, according to an example embodiment of the present inventive concept.

FIG. 4 illustrates a process of monitoring and automatically feeding a plurality of different pets individually, according to an example embodiment of the present inventive concept.

The drawings illustrate a few exemplary embodiments of the present inventive concept and are not to be considered limiting in its scope, as the overall inventive concept may admit to other equally effective embodiments. The elements and features shown in the drawings are to scale and attempt to clearly illustrate the principles of exemplary embodiments of the present inventive concept. In the drawings, reference numerals designate like or corresponding, but not necessarily identical, elements throughout the several views.

### DETAILED DESCRIPTION OF THE PREFERRED EMBODIMENTS

Reference will now be made in detail to the embodiments of the present general inventive concept, examples of which are illustrated in the accompanying drawings, wherein like reference numerals refer to the like elements throughout. The embodiments are described below in order to explain the present general inventive concept while referring to the figures. Also, while describing the present general inventive concept, detailed descriptions about related well-known functions or configurations that may diminish the clarity of the points of the present general inventive concept are omitted.

It will be understood that although the terms “first” and “second” are used herein to describe various elements, these elements should not be limited by these terms. These terms are only used to distinguish one element from another element. Thus, a first element could be termed a second element, and similarly, a second element may be termed a first element without departing from the teachings of this disclosure.

Expressions such as “at least one of,” when preceding a list of elements, modify the entire list of elements and do not modify the individual elements of the list.

All terms including descriptive or technical terms which are used herein should be construed as having meanings that are obvious to one of ordinary skill in the art. However, the terms may have different meanings according to an intention of one of ordinary skill in the art, case precedents, or the appearance of new technologies. Also, some terms may be arbitrarily selected by the applicant, and in this case, the meaning of the selected terms will be described in detail in the detailed description provided herein. Thus, the terms used herein have to be defined based on the meaning of the terms together with the description throughout the specification.

Also, when a part “includes” or “comprises” an element, unless there is a particular description contrary thereto, the part can further include other elements, not excluding the other elements. In the following description, terms such as “unit” and “module” indicate a unit to process at least one function or operation, wherein the unit and the module may be embodied as hardware or software or embodied by combining hardware and software.

Hereinafter, one or more exemplary embodiments of the present general inventive concept will be described in detail with reference to accompanying drawings.

Exemplary embodiments of the present general inventive concept are directed to a system to detect individual pets among a plurality of pets, and to manage pet services for each of the individual pets based on the detection of each pet such that unique services can be provided to each individual pet based on the detection of the pet at each of a plurality of respective pet servicing locations.

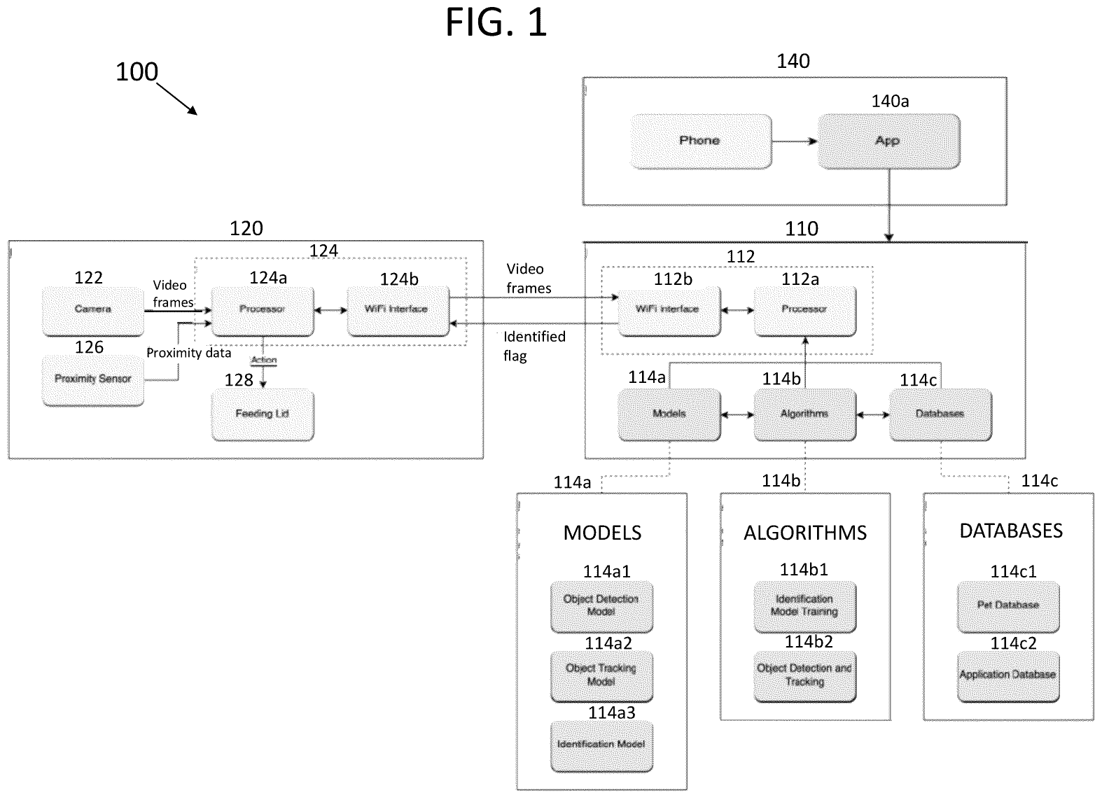

FIG. 1 illustrates a pet management system 100 configured to learn detailed information regarding a plurality of different pets and to manage pet services to be provided to the each of the pets based on identification of each pet, according to an example embodiments of the present inventive concept. Referring to FIG. 1, an edge computer control system 110, pet feeder devices 120 (only one is illustrated in order to provide brevity of the detailed description), and user devices 140 with a downloaded App 140a are provided, where the App 140a is a part of the pet management system 100. The App 140a of the pet management system 100 enables users to take videos of their pets using a mobile electronic device 140 and to upload these videos to the edge computer control system 110 for processing.

The edge computer control system 110 can include an embedded system 112 having storage and hardware for running artificial intelligence (AI) algorithms and models. The embedded system 112 can include one or more processors 112a and a WiFi interface 112b for communicating with various different appliances (aka: pet servicing devices 120) used to provide services for pets. Alternatively, the interface 112b can be an Internet communications interface or a Bluetooth communications interface, depending on the locational setup of the overall pet management system 100.

Some appliance devices usable with the present inventive concept to provide services to pets, in the pet management system 100 according to the example embodiment of FIG. 1, can include, for example, a pet feeding device 120, a pet watering device, a pet treat dispensing device, a pet medication device, etc. Other pet servicing devices can also be included and controlled by the embedded system 112. The edge computer control system 110 is configured to manage at least three software tasks: 1) managing AI models 114a, where the AI models require maintenance in the form of storage, training, and retraining (the edge computer control system 110 is configured to ensure that these AI models are continuously updated and remain stable); 2) managing algorithms 114b, where the algorithms are software functions that are run when certain criteria are met and will generate information or perform an action upon execution thereof; and 3) manage a database 114c. The database 114c can include a pet database 114cl which stores all data related to each of a plurality of pets, such as pet names and their corresponding videos, and an application database 114c2 which stores schedules of services for each of the plurality of pets, among other applications.

The pet feeder devices 120 can each include a camera 122, which can capture live video of an area near or surrounding the corresponding pet feeder 120. This captured video can be processed by one or more processors 124a and transmitted over a WiFi 124b interface (or Internet or Bluetooth) to the embedded system 112 of the edge computer control system 110. The pet feeder devices 120 can each also include a proximity sensor 126 which can detect, denoted as a proximity detection, whether an object is near the pet feeder, and can also determine the distance an object is away from the pet feeder device 120. The proximity sensor 126 can be disposed alongside the corresponding camera 122 so that in the event where the camera 122 becomes blocked, such as when a large pet is directly in front of the pet feeder device 120, an object can still be detected to be in proximity to the pet feeder device 120. The pet feeder devices 120 can also include an embedded system 124, which can include the one or more processors 124a and the WiFi interface 124b. The embedded system 124 of the pet feeder devices 120 can be a small computer that contains specific hardware to perform specific programmed tasks as described herein. For each of the pet feeder devices 120 the embedded system 124 can include one or more processors 124a and a WiFi interface 124b.

The pet feeder devices 120 (or pet servicing devices) can each also include a feeding lid device 128 (or other pet service enabling device). Here the feeding lid device 128 can include a lid and an actuator combination (not illustrated) to move the lid 128 with respect to the pet feeder device 120 when actuated by a control signal, where the pet feeder devices 120 are controlled by the embedded system 124. Each feeding lid device 128 can be controlled by the embedded system 124 such that the actuators are actuated to either open or close the feeding lid device 128 (or other pet service enabling device) in order to expose or block food in the pet feeder device 120 from being accessed and eaten. It is to be noted that other equivalent pet service enabling devices can be provided in the pet management system 100 as well as a pet feeder device 120 and corresponding feeding lid device 128, which will perform the functions of servicing pets, without departing from the spirit and scope of the overall present inventive concept as described herein. A few examples of other pet servicing devices can include, for example, a pet watering device, a pet treats providing device or a pet medication dispensing device, which will each also include a feeding lid or other dispense enabling device that corresponds with the pet services device. For brevity of the detailed description herein only the pet feeder device 120 will be referenced below.

The downloadable App 140a provides a user with a graphical user interface (GUI) for controlling the edge computer device 110 and pet feeder device(s) 120. The App 140 provides the user with the capability to schedule feeding times of a pet feeder device 120, and also enables a user at the App 140a to provide names of pets and to upload videos of pets to the edge computer device 110 for all AI models, which are described in more detail below.

Referring back to the edge computer control system 110 in FIG. 1, AI Models 114a can include an Object Detection Model 114a1, an Object Tracking Model 114a2 and an Identification Model 114a3.

The Object Detection Model 114al is configured to find where objects of interest (i.e., dogs and cats) are located within a video frame. For example, if an image is captured with a dog or cat in the image and this image is uploaded to the edge computer control system 110, the Object Detection Model 114al will determine and return coordinates of where the dog and cat are located, as well as provide labels (i.e., “dog” or “cat”) for the respective coordinate. An example of a software algorithm that can be used for this process is YOLO or CenterNet open sourced deep neural network models.

The Object Tracking Model 114a2 is configured to track objects by identifying whether the detected object coordinates in one frame from the object detection model are the same coordinates from previous frames. For example, if provided a video of two dogs, the Object Tracking Model 114a2 will be able to determine which dog in the first frame is the same dog in the last frame. An example of a software algorithm that can be used for this process is the Simple Online Realtime Tracking algorithm.

The Identification Model 114a3 is configured to associate a detected object with a user specified label. In the present inventive concept users can provide images and videos of their pets, as well as the names of these pets. The Identification Model 114a3 can then further categorize the detected object from the Object Detection Model 114al into the user's specific pet names. For example, if a user has two dogs, i.e., names Buddy and Max, the Identification Model 114a3 will return “Buddy” or “Max,” as opposed to just returning “dog” from the Object Detection Model 114al. An example of a software algorithm that can be used for this process is the Siamese Neural Network

Still referring to the edge computer control system 110 in FIG. 1, algorithms 114b will function depending on the phase in which the edge computer control system 110 is in. The edge computer control system 110 includes a first phase, which is referred to herein as a “setup” phase and a second phase, which is referred to herein as a “runtime” phase. The setup phase designates preparation of the pet management system 100, where a user uploads videos of their specific pet, provides a name of the pet, and enters scheduled feeding times for the pet, which can all be stored within the databases 114c. The runtime phase designates that the edge computer control system 110 is operational and will detect, track, identify, and feed pets.

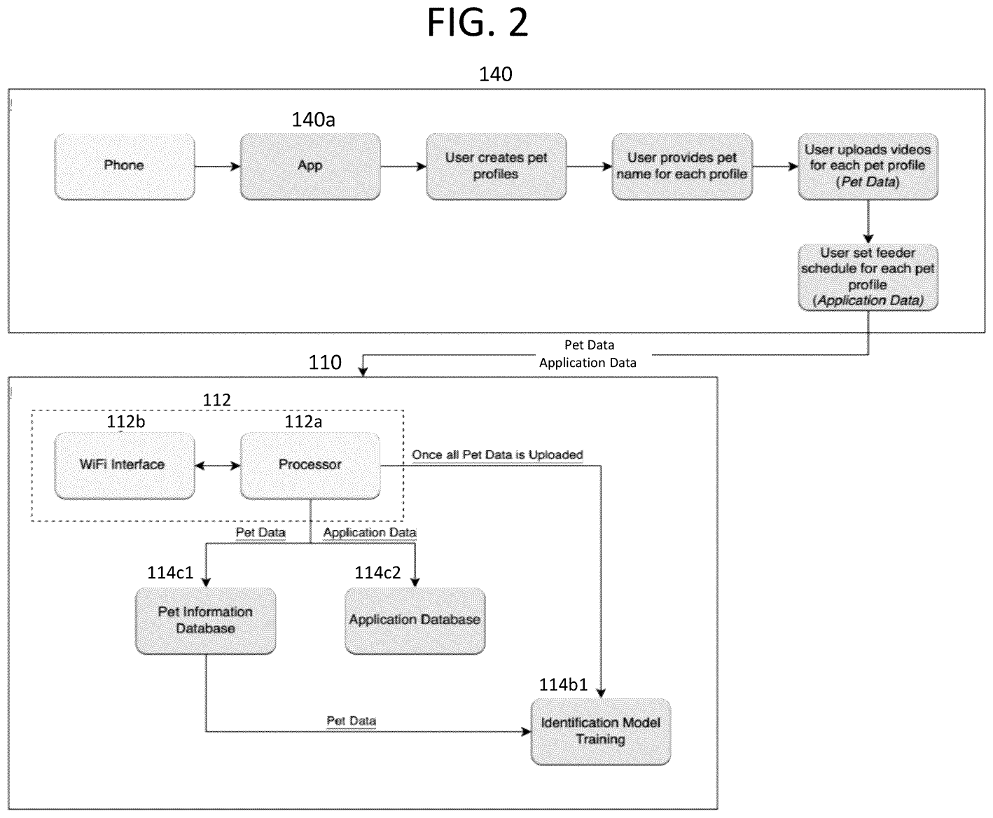

FIG. 2 illustrates a setup process (or the “setup” phase) for training the computing system 110, according to an example embodiment of the present inventive concept, to learn how to identify different pets among a plurality of pets entered into the pet management system 100. The setup phase begins with a user creating a profile for a pet, which requires a name to be provided for the pet. For each of these profiles created, the user will upload videos of the specific pet as well as enter the pet's feeding schedule. This can be accomplished via a mobile device 140 or through a website of the pet management system 100. The name and videos of a pet are referred to as “Pet Data” and the feeding schedule (as well as other pet service actions) is referred to as “Application Data.” In this setup phase the user can first confirm the information provided at the App 140a (or website), and then the user can send the Pet Data and the Application Data to the edge computer control system 110 by uploading this data through the App 140a (or directly via the website). The edge computer control system 110 can then populate the Pet Data in a Pet Database 114cl within the database 114c and can populate the Application Data in an Application Database 114c2 within the database 114c.

After all the pet data and application data is populated in the designated databases the edge computer control system 110 can execute the Identification Model Training algorithm 114b1, where the data in the Pet Database 114cl is used to train an Identification Model 114a3 to be able to identify the user's specific pet or pets. After the particular Identification Model 114a3 is trained this Model 114a3 can be saved within a storage within the edge computer control system 110.

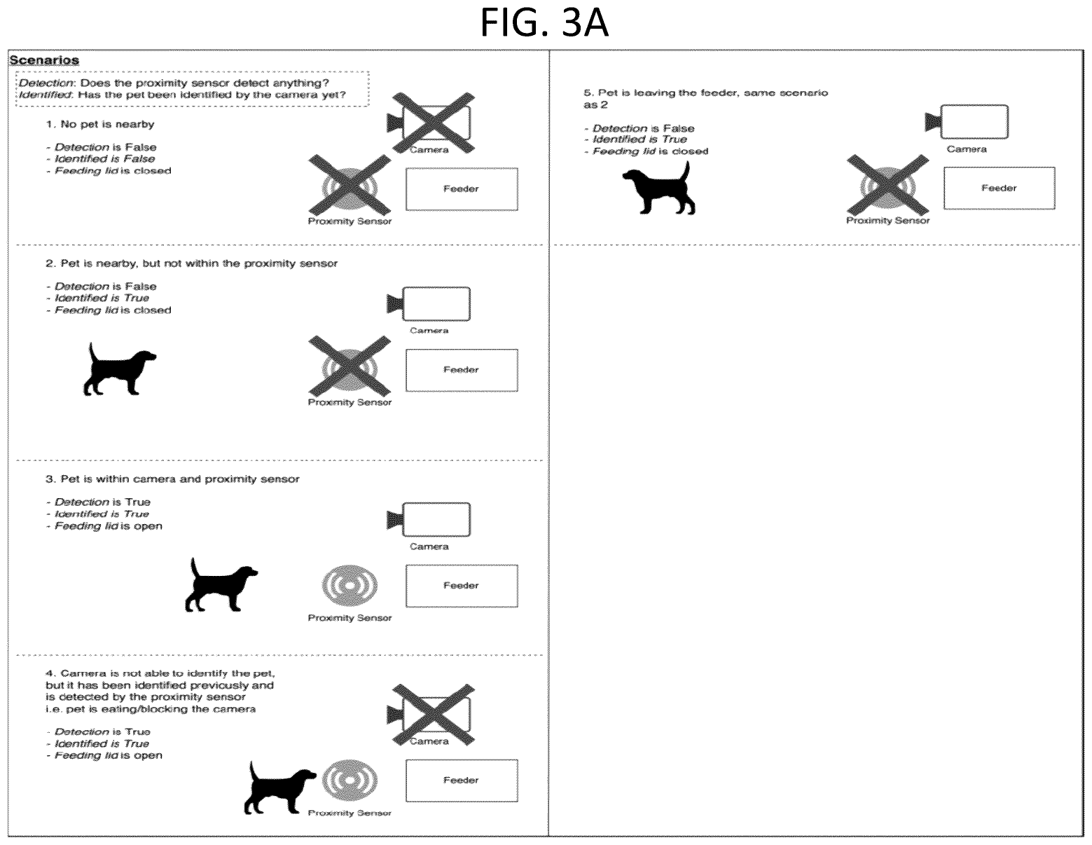

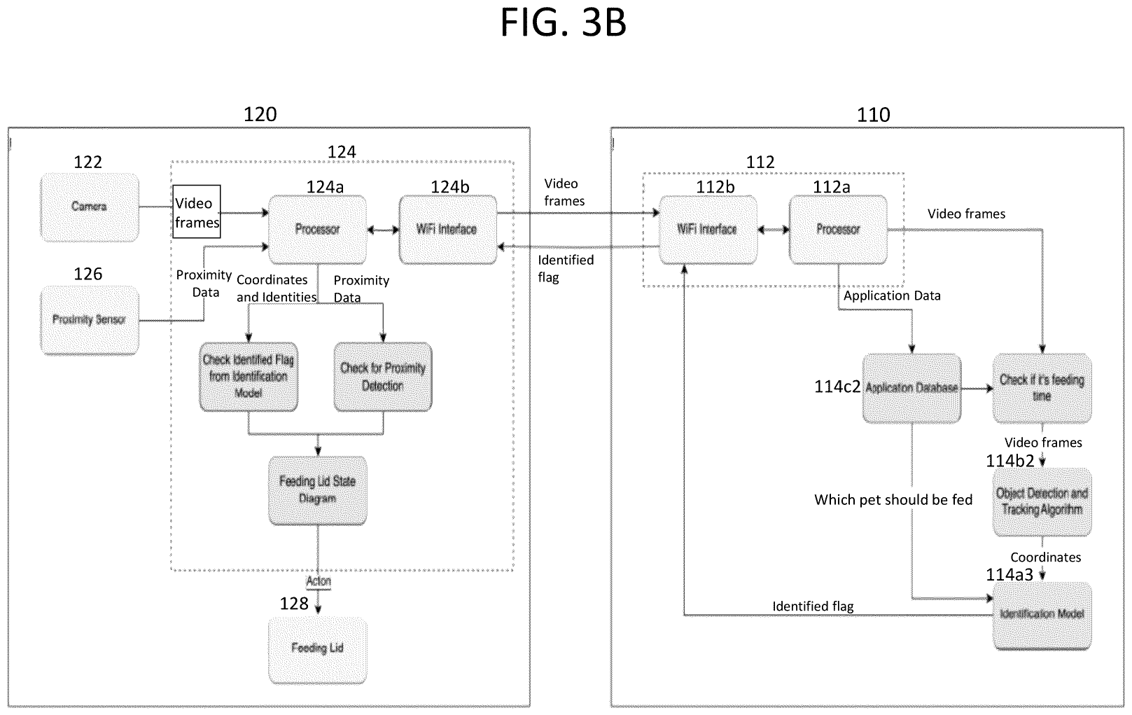

FIG. 3A illustrates the overall second “runtime” phase operations performed to manage a plurality of pets based on a trained computing system, as described in FIG. 2, according to an example embodiment of the present inventive concept. FIG. 3B illustrates a summary of the operations of the different units in the edge computer control system 110 and in the pet feeder device 120 during the second “runtime” phase, according to an example embodiment of the present inventive concept.

Referring to FIGS. 3A and 3B, the runtime phase continuously operates by first having the edge computer control system 110 check whether a scheduled “feeding event” occurs for a pet from the scheduled feeding events stored in the Application Database 114c2. If a scheduled feeding event occurs the runtime phase continues to a next step, otherwise the runtime phase continues to check for a scheduled feeding event to occur.

When a scheduled feeding event is determined to occur the edge computer control system 110 will begin processing video frames from the videos transmitted from the embedded system 124 (taken at the camera 122) of the pet feeder 120 through the Object Detection and Tracking Algorithms 114b2. The Object Detection and Tracking Algorithms 114b2 use the Object Detection Model 114al and the Object Tracking Model 114a2 to help detect pets and where the detected pets are located from the video frames and to provide coordinates, as well as the class label of the pets (i.e., the type of pet).

If no pet is detected in the video frames transmitted from the embedded system 124 (taken at the camera 122) of the pet feeder 120 by the Object Detection and Tracking Algorithms of the edge computer control system 110, and the proximity sensor 126 of the pet feeder 120 does not confirm a proximity detection of a pet within proximity to the pet feeder associated with the occurred feeding event, the pet feeder lid 128 associated with the feeding event will remain closed by control of the processor 124a.

If there are any pets in the video frames of the video transmitted by the embedded system 124 (taken at the camera 122) of the pet feeder 120 the detected object(s) within each video frame received are captured and sent through the Identification Model 114a3, which will determine the pet's identity (i.e., will determine which specific user the pet belongs to). If a pet that is identified by the Identification Model 114a3 is determined to be a pet associated with an occurred feeding event the edge computer control system 110 will transmit back to the pet feeder 120 a “TRUE” identification flag indicating that the pet associated with the occurred feeding event is identified, otherwise a “FALSE” will be indicated. The pet feeder 120 will use the “TRUE” identification flag, alongside its own proximity detection data obtained from the proximity sensor 126, to determine whether the feeding lid 128 for the pet associated with an occurred feeding event should be open or closed. More specifically, referring to Scenario 2 of FIG. 3A, if the identification (by image data from camera 122) of a pet associated with an occurred feeding event is determined to be TRUE but the detection (proximity detection data by the proximity sensor 126) of a pet within proximity of the pet feeder associated with the occurred feeding event is FALSE, then the processor 124a of the pet feeder device 120 will cause the feeder lid 128 for the specific pet to remain closed by control of the processor 124a.

In Scenario 3 of FIG. 3A, if the identification of a pet associated with an occurred feeding event is determined to be TRUE (by image data from camera 122) and the detection (proximity detection data by the proximity sensor 126) of a pet within proximity to the pet feeder associated with the occurred feeding event is TRUE, then the processor 124a of the pet feeder device 120 will cause pet feeder lid 128 for the specific pet to be opened by the processor 124a.

In Scenario 4 of FIG. 3A, if the camera 122 is not able to identify the pet associated with a feeding event which has occurred (i.e., a pet may be eating/blocking the camera), but the pet has been identified previously, and the proximity detection by the proximity sensor 126 of a pet is TRUE, then the processor 124a of the pet feeder device 120 will cause the feeding lid 128 of the pet feeder 120 associated with the occurred feeding event to be opened by the processor 124a.

As illustrated in Scenario 5 of FIG. 3A, when a pet is leaving (or has left) the pet feeder 120 in which a feeding event has occurred, the identification of the pet associated with the occurred feeding event will be determined to be a TRUE flag, but the proximity detection signal of a pet by the proximity sensor 126 within the proximity to the pet feeder will be a FALSE, thus resulting in the feeding lid 128 of the pet feeder device 120 associated with the occurred feeding event being closed by the processor 124a.

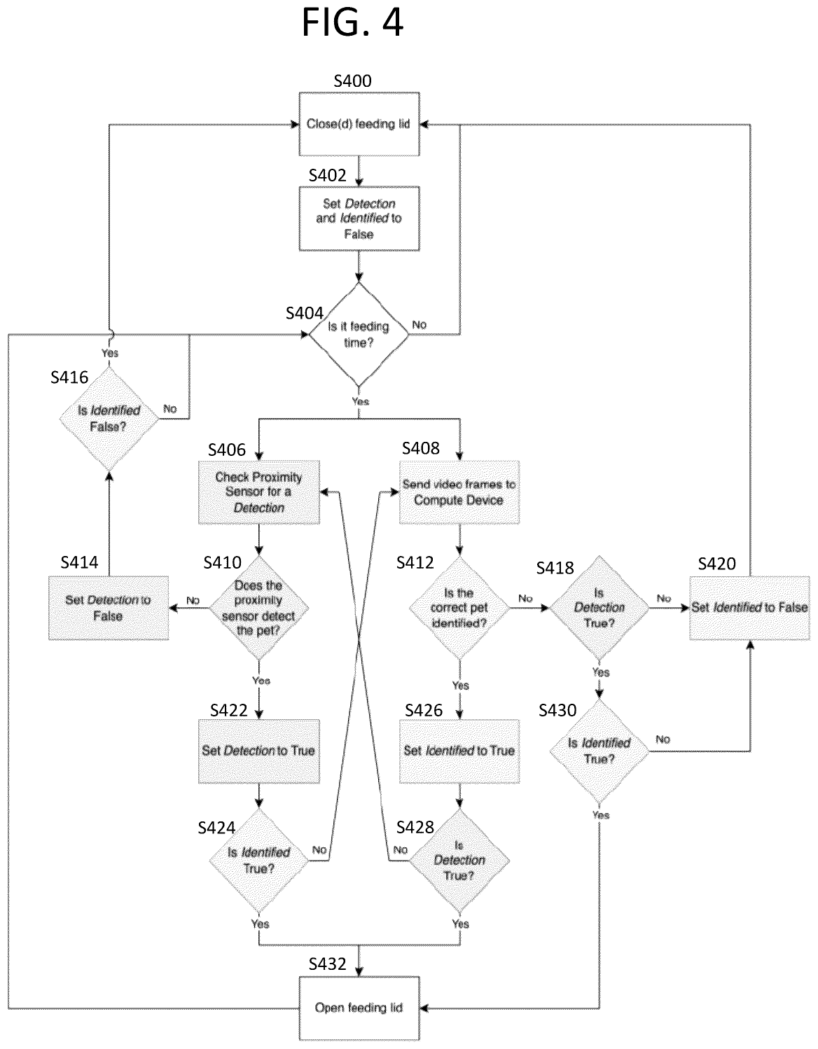

FIG. 4 illustrates a flowchart of a pet management process, according to an example embodiment of the present inventive concept. Referring to FIG. 4, a feeding lid for each of a plurality of pet feeder devices within a pet management system are closed at Step 400 (S400) before a scheduled feeding event occurs. In order to provide brevity and clarity to the detailed description of the pet management process according to the present example embodiment, the following description will refer to one pet feeder device associated with one pet. However, the pet management process according to the present example embodiment is configured to manage each of a plurality of pet feeder devices within the pet management system, where each of the plurality of pet feeder devices corresponds to a different pet among a plurality of pets entered into the pet management system. It is to be noted that the pet management process according to the present example embodiment can also be operable to manage other pet service devices as well as pet feeder devices, without departing from the spirit and scope of the present inventive concept.

At a time period before a scheduled feeding event occurs (S400) a pet proximity detector, disposed in proximity to the pet feeder, will set a pet detector signal to FALSE at Step S402 and a pet identification camera, disposed at a position to capture videos of an area around the pet feeder device, will not begin capturing any video images. An edge computer control system included in the pet management process according to the present example embodiment is configured to determine whether a specific pet, associated with a pet feeder device in which a pet feeding event has occurred, is identified by executing specifically configured algorithms to determine whether images received from the pet identification camera include the specific pet associated with an occurrence of a scheduled pet feeding event. Also, at step S402 the edge computer control system will set a pet identified signal to FALSE. At step S406 the edge computer control system will then continuously search for a scheduled feeding event associated with the pet feeder to occur.

Once a pet feeding event has been determined to occur for a specific pet associated with the pet feeder, the edge computer control system will check whether the proximity detector has detected a pet to be in proximity to the pet feeder at step S406. Further, the edge computer control system will request videos to be taken by the pet identification camera and be transmitted to the edge computer control system at step S408 in order for the edge computer control system to perform an analysis as to whether the specific pet associated with the pet feeder has been identified. When the specific pet has been identified in the video frames of the videos received, the edge computer control system will set the pet identified signal to TRUE at step S426. If the pet proximity detector has not detected a pet to be in proximity to the pet feeder at step S410 the detector signal will be set to FALSE at step S414 and the pet feeder lid of the pet feeder will remain closed. In contrast, if the pet proximity detector has detected a pet to be in proximity to the pet feeder at step S410 the pet detector signal will be set to TRUE at step S422 and the edge computer control system of the pet management system will check whether the pet identification signal is TRUE at step S424. If both the pet detector signal is determined to be set to TRUE at step S422 and the pet identification signal is determined to be set to TRUE at step S424 then the pet feeder lid associated with the scheduled pet feeding event occurrence will be opened at step S432.

Alternatively, if the pet detector signal is set to TRUE at step S422 and the pet identification signal is set to FALSE at step S424 then the lid of the pet feeder associated with the pet feeding event occurrence will continue to remain closed while the edge computer control system requests and receives more videos from the pet identification camera at step S408. If the additional videos determine that the correct pet is identified at step S412 then the pet detection sensor will again be checked for the detection of a pet at step S418. If the pet is not detected at step S418 the edge computer control system will set the pet detection signal to FALSE at step S420 and the system will refer back to step S400. Alternatively, if the pet is detected at step S418 and the correct pet continues to be identified (TRUE) then at step S430 the pet feeder lid associated with the scheduled pet feeding event occurrence will be opened at step S432.

Alternatively, once the videos received and analyzed by the edge computer control system result in a determination that the correct pet has been identified at step S412 the edge computer control system will set the pet identification signal to TRUE at step S426. At this time if the pet detection signal is still TRUE at step S428 then the pet feeder lid associated with the scheduled pet feeding event occurrence will be opened at step S432. Otherwise, when the pet identification signal is set to TRUE at step S426 and the pet detection signal is FALSE at step S428 the edge computer control system will again check the proximity sensor for a detection of a pet at step S406 and then advance to steps S410, S422 and S424 again, as described above. This process will be continuously be performed, as illustrated in FIG. 4, until either both the pet detector signal is set to TRUE at S422 and the pet identification signal is set to TRUE at S424, or until the pet identification signal is set to TRUE at step S426 and the pet detection signal is TRUE at step S428, at which point the pet feeder lid associated with the scheduled pet feeding event occurrence will be opened at step S432.

While certain features of the example embodiments of the present inventive concept as described herein have been illustrated and described, many modifications, substitutions, changes, and equivalents will now occur to those of ordinary skill in the art. It is therefore to be understood that the appended claims are intended to cover all such modifications and changes as fall within the spirit and scope of the embodiments as described herein.

The embodiments described herein may also be implemented in a computer program to be used to run a computer system, at least including code portions for performing process steps according to the embodiments when run on a programmable apparatus, such as a computer system, or enabling a programmable apparatus to perform functions of a device or system according to the example embodiments.

Although a few embodiments of the present general inventive concept have been shown and described, it will be appreciated by those skilled in the art that changes may be made in these embodiments without departing from the principles and spirit of the general inventive concept, the scope of which is defined in the appended claims and their equivalents.

What is claimed is:

1. A pet management system, comprising:
an edge computer control system including:
an application graphic user interface (GUI) to receive videos of a pet, a name of the pet and a schedule of management times for the pet to create a pet profile;
at least one database to store the pet names, videos and schedules of the pet management times for each pet profile;
a first wireless communications interface to wirelessly communicate with at least one pet management device; and
at least one computer processor configured:
to train and store identification models to analyze video frames of videos received through the GUI to identity a pet and associate the name with the pet,
to transmit instructions to a pet management device assigned to a pet profile to capture videos of pets when a scheduled pet management time occurs;
to store object detection and tracking models to detect and track pets and location coordinates of the pets from video frames received from the assigned pet management device and determine whether a detected pet in one frame is the same pet detected in a later frame, and
to identify the detected and tracked pets and transmit an identification signal confirming whether an identified pet is close to the assigned pet management device through the first wireless communications interface; and
at least one pet management device including:
a second wireless communications interface to wirelessly communicate with the edge computer control system to: receive instructions to capture videos at the pet management device; transmit the captured videos to the edge computer control system; and to receive identification signals from the edge computer control system indicating whether a pet assigned to the pet management device is close to the pet management device;
a proximity detector to detect whether a pet is within proximity to the pet management device, and
a management processor to operate the pet management device to open when the identification confirmation signal received from the edge computer control system confirms that the assigned pet is close to the pet management device; and when the proximity detector detects that a pet is within proximity to the pet management device.

2. The pet management system according to claim 1, wherein the GUI is accessible at personal mobile electronic devices via an App and the Internet.

3. The pet management system according to claim 2, wherein the at least one pet management device includes a plurality of pet management devices, wherein each of the plurality of pet management devices is assigned to a specific pet profile.

4. The pet management system according to claim 2, wherein the at least one database includes:
a pet information database to store input pet names and input videos of pets; and
an application database to store input pet management schedules.

5. The pet management system according to claim 4, wherein the edge computer control system further includes:
a plurality of identification models each programmable to identify a pet from the created pet profiles and to identify a pet from the detected and tracked pet.

6. The pet management system according to claim 4, wherein the edge computer control system further includes:
an object detection model programmable to detect objects from video frames received from the at least one pet management device; and
an object tracking model programmable to track the detected objects and determine coordinates of the detected objects.

7. The pet management system according to claim 1, wherein the at least one pet management device is a pet feeder device.

8. A pet management system, comprising:
an edge computer control system including:
an application graphic user interface (GUI) to receive videos of a pet, a name of the pet and a schedule of management times for the pet to create a pet profile;
at least one database to store the pet names, videos and schedules of the pet management times for each pet profile;
a first wireless communications interface to wirelessly communicate with at least one pet management device; and
at least one computer processor configured:
to identify pets using the videos and pet names received through the GUI,
to transmit instructions to one of a plurality of pet management devices to capture videos of pets within a surrounding environment when a scheduled pet management time occurs;
to detect objects and location coordinates of the objects from video frames received from the one of a plurality of pet management devices and determine whether a detected object in one frame is the same object detected in a later frame, and
to identify a specific pet from the detected and tracked objects and transmit identification signals confirming whether the identified pet is close to the one of a plurality of pet management devices through the first wireless communications interface; and
at least one pet management device including:
a second wireless communications interface to wirelessly communicate with the edge computer control system to: receive instructions to capture videos; transmit the captured videos to the edge computer control system; and receive the transmitted identification signals from the edge computer control system;
a proximity detector to detect whether an object is within proximity to the pet management device, and
a management processor to operate the pet management device to open when: an identification signal received from the edge computer control system confirms that the pet is close to the pet management device; and when the proximity detector detects that an object is within proximity to the pet management device.

9. The pet management system according to claim 8, wherein the at least one pet management device is a pet feeder device.

10. A method of managing pets with a pet management control system, the method comprising:
generating a graphic user interface (GUI) accessible via an APP and the Internet, the GUI enabled to receive a pet name and videos of a pet to create a pet profile, and to receive a schedule of management times for the pet;
storing the created pet profiles, the input pet names and scheduled pet management times in at least one database;
training AI based identification models to identify a pet and associate a name with the identified pet from video frames of a pet and a pet name received through the GUI;
wirelessly transmitting instructions to one of a plurality of pet management devices to capture videos when a scheduled pet management time occurs;
receiving the captured videos from the pet management device in response to the instructions transmitted to capture videos;
detecting and tracking location coordinates of a pet in the received video frames and determining whether the detected pet in one frame is the same pet detected in a later frame;
identifying the detected and tracked pet;
wirelessly transmitting identification indication signals to the pet management device which indicate whether the identified pet is within a predetermined distance from the pet management device;
detecting a proximity of an object at the pet management device; and
operating the pet management device to open when the identification indication signal indicates that the specific pet has been identified and when an object has been detected to be within proximity of the pet management device, otherwise keeping the pet management device closed.
